(19) United States
(12) Patent Application Publication
(10) Pub. No.: US 2015/0352392 A1
(43) Pub. Date: Dec. 10, 2015

(54) NANOPARTICLE ENHANCED ACTIVATED CARBON FABRICS

(71) Applicant: Calgon Carbon Corporation, Pittsburgh, PA (US)

(72) Inventor: Robert KAISER, Edmonds, WA (US)

(73) Assignee: Calgon Carbon Corporation, Pittsburgh, PA (US)

(21) Appl. No.: 14/614,931

(22) Filed: Feb. 5, 2015

Related U.S. Application Data
(60) Provisional application No. 61/935,950, filed on Feb. 5, 2014.

(51) Int. Cl. A62D 5/00; D06M 11/36

(52) U.S. Cl. CPC A62D 5/00; D06M 11/36; D06M 2101/40

(57) ABSTRACT

Metal oxide nanoparticle-containing activated carbon cloth and methods for using such cloths for decontamination and protection from hazardous chemical agents are described herein.

### CROSS-REFERENCE TO RELATED APPLICATIONS

This application claims priority to U.S. Provisional No. 61/935,950 entitled “Nanoparticle Enhanced Activated Carbon Fabrics” filed Feb. 5, 2014, the entire contents of which is hereby incorporated by reference.

### GOVERNMENT INTERESTS

This invention was made with Government support under Contract No. W911QY-13-C-0029 awarded by the U.S. Army Natick Soldier Systems Center. The United States Government has certain rights in this invention.

### PARTIES TO A JOINT RESEARCH AGREEMENT

Not applicable

### INCORPORATION BY REFERENCE OF MATERIAL SUBMITTED ON A COMPACT DISC

Not applicable

### BACKGROUND

Not applicable

### SUMMARY OF THE INVENTION

Not applicable

### DESCRIPTION OF DRAWINGS

Not applicable

### DETAILED DESCRIPTION

Before the present compositions and methods are described, it is to be understood that they are not limited to the particular compositions, methodologies or protocols described, as these may vary. It is also to be understood that the terminology used in the description is for the purpose of describing the particular versions or embodiments only, and is not intended to limit their scope, which will be limited only by the appended claims.

It must also be noted that as used herein and in the appended claims, the singular forms “a,” “an,” and “the” include plural reference unless the context clearly dictates otherwise. Unless defined otherwise, all technical and scientific terms used herein have the same meanings as commonly understood by one of ordinary skill in the art. Although any methods and materials similar or equivalent to those described herein can be used in the practice or testing of embodiments disclosed, the preferred methods, devices, and materials are now described.

“Optional” or “optionally” means that the subsequently described event or circumstance may or may not occur, and that the description includes instances where the event occurs and instances where it does not.

“Substantially no” means that the subsequently described event may occur at most about less than 10% of the time, or the subsequently described component may be at most about less than 10% of the total composition, in some embodiments, and in others, at most about less than 5%, and in still others at most about less than 1%.

Hazardous chemicals, such as chemical warfare agents, have become increasingly potent weapons, and protecting soldiers from these agents is critical. Over-garments that contain activated carbon that adsorbs the hazardous chemicals is commonly used to provide protection from chemical weapons. However, these activated carbon systems have a finite protection life and only work until the adsorption capacity of a system is reached, at which point, the garments can be breached by the chemical agent poisoning the wearer. Therefore, there is a need for activated carbon-containing over-garments with improved adsorption capacity to adequately protect soldiers from chemical warfare agents.

Various embodiments of the invention are directed to activated carbon cloth including dispersed nanoparticles of metal oxides, methods for producing such activated carbon cloths, methods for using these activated carbon cloths, and garments and other articles of manufacture produced from these activated carbon cloths. Without wishing to be bound by theory, the activated carbon cloth of embodiments including metal oxide nanoparticles may increase the protection life of the activated carbon cloth by physically altering or degrading hazardous chemicals, rendering them harmless. Moreover, degradation reduces adsorption of the agent by the activated carbon cloth lengthening the time period before adsorption capacity is reached and lengthening the useful life of the activated carbon cloth.

The activated carbon cloth of various embodiments may include nanoparticles composed of any metal oxide known in the art. For example, in some embodiments, nanoparticles may be composed of oxides of alkaline earth metals such as beryllium (Be), magnesium (Mg), calcium (Ca), strontium (Sr), barium (Ba), or radium (Ra), oxides of light metals such as aluminum (Al), scandium (Sc), titanium (Ti), vanadium (V), chromium (Cr), manganese (Mn), iron (Fe), cobalt (Co), or nickel (Ni), oxides of certain heavy metals such as copper (Cu), zinc (Zn), yttrium (Y), zirconium (Zr), ruthenium (Ru), silver (Ag), tin (Sn), lanthanum (La), tungsten (W), platinum (Pt), or cerium (Ce), and various alloys and combinations of thereof. In particular embodiments, the activated carbon cloth may include nanoparticles of silicon oxide alone or in combination with any of the metal oxides described above or combinations of these metal oxides, combinations of metal oxides alloys, or combinations of metal oxides and metal oxide alloys. In certain embodiments, the metal oxide particles may be composed of MgO, CaO, ZnO, Al₂O₃, TiO₂, V₂O₅, Cr₂O₃, MnO₂, MnO₃, FeO, Fe₂O₃, CoO, NiO, CuO, ZnO, Y₂O₃, ZrO₂, SnO₂, La₂O₃, WO₃, CeOₓ, SiO₂, or combinations thereof. In embodiments in which combinations of metal oxides are present in the activated carbon cloth, each metal oxide or metal oxide alloy may be present in separate, individual nanoparticles. In some embodiments, the various metal oxides, metal oxide alloys, or combinations thereof may be combined into a single nanoparticle species containing different metal oxides. For example, the nanoparticles may be composed of clusters of particles containing each metal oxide or the metal oxides may be blended in a single particle. In some embodiments, the activated carbon cloth may include nanoparticles composed of alkaline earth metals, light metals, or heavy metals described above in the form of metal complexes of hydroxides, metal complexes of hydrates, or polyoxometallates (POMs), and nanoparticles of these hydroxides, hydrates, and POMs may be present in the activated carbon cloth alone or in combination with the metal oxides or metal oxide alloys described above.

In certain embodiments, the nanoparticles described above may be processed to include, for example, reactive halogen atoms, alkali metal atoms, or additional metal oxides. In some embodiments, the processing may provide additional materials that act to activate or otherwise improve the rate of decomposition of chemical agents. For example, the nanoparticles may include elemental platinum (Pt), which can activate certain metal oxides such as MgO or ZnO, increasing the efficiency of chemical agent decomposition. Other activators are known in the art and can be included in any of the nanoparticles described above. In still other embodiments, the nanoparticles can be processed to include a protective coating to render them waterproof or to reduce the likelihood of side reactions.

The size and shape of the nanoparticles attached to the activated carbon cloth of such embodiments may vary among embodiments. For example, the nanoparticles may be substantially spherical, substantially cylindrical, or crystalline in shape, and in some embodiments, the nanoparticles may have an amorphous appearance. The mean particle diameter (MPD) of the particles may vary depending on, for example, the shape of the nanoparticles, and can be about 1 nm to about 200 nm. In certain embodiments, the MPD of the nanoparticles may be about 2 nm to about 150 nm, about 2 nm to about 100 nm, about 5 nm to about 75 nm, about 10 nm to about 50 nm, or any range or individual MPD encompassed by these example ranges. Such nanoparticles may typically have a Brunauer-Emmett-Teller (BET) multi-point surface area of about 50 m²/g or greater to about 2500 m²/g or more. In particular embodiments, the BET surface area of the nanoparticles associated with the activated carbon cloth of embodiments may be from about 100 m²/g to about 2000 m²/g, about 200 m²/g to about 1500 m²/g, or any range or individual BET surface area encompassed by these example ranges, and in particular embodiments, the nanoparticles may have a BET surface area of greater than 1200 m²/g. The nanoparticles of such embodiments may be porous and can have an average pore radius of about 45 Angstroms (4.5 nm) to about 100 Angstroms (10 nm) or any range or individual radius encompassed by this range.

The nanoparticles described above can be associated with the activated carbon cloth in any way, and in certain embodiments, the nanoparticles may be physically attached or bonded to the activated carbon cloth such that the nanoparticles are immobilized on the surface of activated carbon cloth. The nanoparticles may be well dispersed over the surface of the activated carbon cloth and exhibit a low degree to agglomeration. Nanoparticles having a small MPD such as, for example, about 1 nm to about 50 nm, about 2 nm to about 20 nm, or about 2 nm to about 10 nm may be particularly well suited for the production of activated carbon cloths having well dispersed nanoparticles. In some embodiments, the metal oxide nanoparticles may make up about 1 wt % to 50 wt %, about 2 wt. % to about 40 wt. %, about 5 wt. % to about 30 wt. % base on the total weight of the metal oxide nanoparticle-containing activated carbon cloth or any range or individual percentage encompassed by these example ranges. In some embodiments, the metal oxide nanoparticles may make up about 0.5% to about 10%, about 1% to about 8%, about 2% to about 6% of the total surface area of the metal oxide nanoparticle-containing activated carbon cloth, or any range or individual percentage encompassed by these example ranges.

Embodiments are not limited by a particular type of activated carbon cloth. For example, the activated carbon cloth of various embodiments may be a woven, non-woven, knitted, or felt activated carbon cloth. Such activated carbon cloths may typically be composed of activated carbon fibers. However, in some embodiments, the activated carbon cloth may contain activated carbon particles, activated carbon powder, or a combination of these materials in addition to activated carbon fibers, or the carbon particles, activated carbon powder, or a combination of these materials immobilized on a cloth that is composed of activated carbon fibers. For example, in some embodiments, activated carbon particles may be immobilized or attached to a non-activated carbon base-cloth, and in other embodiments, activated carbon particles, powder, and/or fibers may be contained between sealed layers of a non-activated carbon base-cloth.

In particular embodiments, the activated carbon cloth may be composed of up to 100% activated carbon, excluding any nanoparticles associated with the activated carbon cloth. For example, the activated carbon cloth may be composed of about 90% to about 100%, about 95% to about 100%, or about 98% to about 100% activated carbon. The thickness of the activated carbon cloth may vary among embodiments and may vary depending on the form, i.e., knitted, woven, or felt, of the activated carbon cloth. In various embodiments, the average thickness of the activated carbon cloth may be from about 0.3 mm to about 2.0 mm, about 0.4 mm to about 1.5 mm, about 0.5 mm to about 1.0 mm, or any range or individual thickness encompassed by these example ranges. Such activated carbon cloths may exhibit a surface density of from about 100 g/m² to about 250 g/m², about 110 g/m² to about 220 g/m², about 120 g/m² to about 200 g/m², about 130 g/m² to about 160 g/m², or any range or individual surface density encompassed by these example ranges.

Such activated carbon cloths may include any of the nanoparticles described above including metal oxide, alkaline earth metal oxide, light metal oxide, heavy metal oxide, alkaline earth metal, light metal, or heavy metal complexes of hydroxides, alkaline earth metal, light metal, or heavy metal complexes of hydrates, or alkaline earth metal, light metal, or heavy metal polyoxometallates, or any such nanoparticles including activators or that have been processed (i.e., metal oxide nanoparticles).

The metal oxide nanoparticle-containing activated carbon cloth of various embodiments described above may exhibit excellent adsorption capacity with improved protective life. For purposes of this disclosure, “protective life” will refer to the time period between the initial chemical agent challenge and adsorption capacity of the activated carbon cloth, which can be observed by increased flow of the chemical agent through the activated carbon cloth. In various embodiments, the protective life may be up to about 48 hours, and in some embodiments, the protective life may be from about 10 hours to about 40 hours, about 20 hours to about 36 hours, or any range or time period encompassed by these example ranges. Of course, the protective life may vary depending on the concentration of the chemical agent and the dissipation of the agent during the challenge.

Further embodiments are directed to articles of manufacture including the metal oxide nanoparticle-containing activated carbon cloths described above. The articles of such embodiments may include one or more layer of any of the metal oxide nanoparticle-containing activated carbon cloths described above or a combination of different activated carbon cloths. In addition, such articles may contain one or more non-activated carbon cloth layers that can be attached to the metal oxide nanoparticle-containing activated carbon cloth of embodiments to provide, for example, structural support, weatherproofing, waterproofing, fire resistance, and the like or combinations of such features. Such laminate materials are known in the art, and the metal oxide nanoparticle-containing activated carbon cloth can be incorporated into any such laminate material.

Embodiments are not limited to any particular type of article. For example, in various embodiments, the metal oxide nanoparticle-containing activated carbon cloth may be used as or incorporated into a laminate material that is used as a tarp, tent, cloth barrier, apron, articles of clothing such as, shirts, pants, hats, jackets, overcoats, shoes, boots, booties, jump suits, hoods, and the like, or any other useful article. In other embodiments, the metal oxide nanoparticle-containing activated carbon cloth can be incorporated into filters for gas or liquid purification. In still other embodiments, the metal oxide nanoparticle-containing activated carbon cloth can be used for purposes other than chemical agent capture and neutralization. For example, the metal oxide nanoparticle-containing activated carbon cloth can be used for heterogeneous catalysis or as an anode, cathode, or both in energy storage devices.

As discussed above, the metal oxide nanoparticle-containing activated carbon cloth of various embodiments include nanoparticles that are immobilized on the surface of activated carbon cloth, are well dispersed over the surface of the activated carbon cloth, exhibit a low degree to agglomeration, and have relatively small MPD of from about 1 nm to about 50 nm, about 2 nm to about 20 nm, or about 2 nm to about 10 nm may be particularly well suited for the production of activated carbon cloths having well dispersed nanoparticles. One way of making metal oxide nanoparticle-containing activated carbon cloth having these properties is to form the nanoparticles during the production of the activated carbon cloth from a precursor cloth by dehydrating the cloth with a metal salt (Lewis Acid). This results in simultaneous extended carbonization of the precursor cloth and formation of metal oxide particles that are immobilized on the cloth.

Thus, further embodiments are directed to methods for making the metal oxide nanoparticle-containing activated carbon cloths described above. In general, such methods include the steps of washing a uncarbonized cloth in a solution containing a Lewis acid form of a metal, carbonizing the uncarbonized cloth to produce a carbonized cloth, and activating the carbonized cloth to produce a metal oxide nanoparticle-containing activated carbon cloth. The resulting metal oxide nanoparticle-containing activated carbon cloth will, typically, exhibit the morphology described above having dispersed nanoparticles of a metal oxide produced from the Lewis acid immobilized on the activated carbon cloth. In some embodiments, the method may further include the step of drying the uncarbonized cloth before carbonizing the uncarbonized cloth. Other embodiments may include the steps of processing the metal oxide nanoparticle-containing activated carbon cloth to make the metal oxide nanoparticles or the metal oxide nanoparticle-containing activated carbon cloth itself waterproof or resistant to side reactions or to improve the overall structural stability of the cloth, and in still other embodiments, such methods may include the steps of incorporating the metal oxide nanoparticle-containing activated carbon cloth into a laminate material or article of manufacture such as those described above.

The uncarbonized cloth can be made from any material known in the art for making activated carbon cloth. For example, in various embodiments, the uncarbonized cloth may be composed of rayon, spun viscous fibers (fibranne), solvent spun cellulose, cotton fibers, bast fibers, and the like, or combinations thereof. In certain embodiments, uncarbonized cloth may be made of a cellulose material having a small degree of orientation and a small amount of crystallinity, and in particular embodiments, the uncarbonized cloth may be rayon fabrics or spun viscose fabrics.

The solution containing a Lewis acid form of a metal oxide used in the methods described above can contain any solvent, and in particular embodiments, the solvent may be water or the combination of water and other solvents. Embodiments are not limited to particular Lewis acid forms of the metals described above, and various Lewis acid forms of beryllium (Be), magnesium (Mg), calcium (Ca), strontium (Sr), barium (Ba), radium (Ra), aluminum (Al), scandium (Sc), titanium (Ti), vanadium (V), chromium (Cr), manganese (Mn), iron (Fe), cobalt (Co), nickel (Ni), copper (Cu), zinc (Zn), yttrium (Y), zirconium (Zr), ruthenium (Ru), silver (Ag), tin (Sn), lanthanum (La), tungsten (W), platinum (Pt), and cerium (Ce) are known in the art and commercially available. Any such Lewis acid or combination of Lewis acids may be used in embodiments.

In embodiments in which the washed uncarbonized cloth is dried, drying can be carried out at ambient temperature or under heating at a temperature of typically less than 100° C. In certain embodiments, the uncarbonized cloth may be loosened by bending, flexing, and stretching the cloth after drying to ensure that the finished metal oxide nanoparticle-containing activated carbon cloth has good flexibility.

Carbonizing can be carried out by any means. Carbonizing typically includes the step of heating the washed uncarbonized cloth to a high temperature for a time period sufficient to allow for complete carbonization. For example, in some embodiments, carbonizing may include the step of heating the washed uncarbonized cloth at a temperature of about 1000° C. to about 1300° C. for about 0.5 min to about 2.0 min. In other embodiments, carbonizing may include the step of heating the washed uncarbonized cloth at a temperature of about 100° C. to about 300° C. for about 5 min to about 45 min. In some embodiments, carbonization can be carried out in an inert environment such as under nitrogen, and in certain embodiments, carbonization can be carried out at low pressure, for example, from 5 Pascal (Pa) to about 60 Pa, to aid in the removal of impurities. In some embodiments, carbonization may include a precarbonization step in which the washed uncarbonized cloth is heated at a temperature below the carbonization temperature, for example, about 350° C. to about 450° C., for about 1 min to about 20 min.

In particular embodiments, methods may further include the step of washing the carbonized cloth after carbonizing to remove any impurities that can accumulate on the surface of the activated carbon cloth during carbonization. Post-carbonization washing can be carried out using any solvent, and in some embodiments, post-carbonization washing can be carried out with demineralized water or an aqueous acid solution.

Carbonization typically results in carbon fibers of high purity, greater than 99% carbon content, and an ash content of less than 0.3%. In various embodiments, the alkaline impurity content may be less than about 1500 ppm.

Activation can be carried out by any means, and typically entails heating the carbonized cloth in an oxidizing atmosphere such as steam, carbon dioxide, or a mixture of carbon dioxide and steam. Activation is, typically, carried out at a temperature of about 750° C. to 950° C. for about 5 min to 300 min. As is known in the art, the specific surface area, porosity, and pore structure of the activated carbon may vary depending on the time period in which activation occurs. In certain embodiments, activation may be carried out for a time period sufficient to produce an activated carbon cloth having a specific surface area of greater than 800 m²/g or even greater than 1200 m²/g, for example, from about 100 m²/g to about 2000 m²/g, about 200 m²/g to about 1500 m²/g, or any range or individual specific surface area encompassed by these example ranges. The activated carbon cloth may have pores with a mean diameter of 0.3 nm to 3 nm and overall porosity lying in the range 30% to 50%.

In some embodiments, the method may further include laminating the metal oxide nanoparticle-containing activated carbon cloth produced as described above. Laminating can include the steps of attaching one or more layers of metal oxide nanoparticle-containing activated carbon cloth to one another, attaching one or more layers of metal oxide nanoparticle-containing activated carbon cloth to one or more layers of non-activated carbon cloth, or combinations thereof. Attaching can be carried out by any means. For example, attaching can be carried out using adhesives, crosslinking non-activated carbon cloth layers to one another, physical attachment such as sewing the various layers to one another, or combinations of these.

In further embodiments, the methods may include the steps of cutting the metal oxide nanoparticle-containing activated carbon cloth or a laminate including one or more metal oxide nanoparticle-containing activated carbon cloth layers and producing an article of manufacture from the metal oxide nanoparticle-containing activated carbon cloth or laminate.

Additional embodiments are directed to methods of using metal oxide nanoparticle-containing activated carbon cloth. As discussed above, the metal oxide nanoparticle-containing activated carbon cloth of various embodiments may provide a barrier to chemical agents having an improved useful lifetime. As such, the metal oxide nanoparticle-containing activated carbon cloth of such embodiments can be used to cover personnel, machines, or other valuable assets from chemical agents. Such coverings may be in the form of tarps, tents, clothing, and the like. In other embodiments, the metal oxide nanoparticle-containing activated carbon cloth of embodiments may be incorporated into filters or breathing apparatuses that are used to block the transmission of chemical agents. In still other embodiments, the metal oxide nanoparticle-containing activated carbon cloth can be used to protect medical personnel from contacting chemical agents carried by patients, and the metal oxide nanoparticle-containing activated carbon cloth can be used in aprons, gowns, scrubs, masks, bed sheets, containment tents, and the like that can be used by the medical personnel. In yet other embodiments, the metal oxide nanoparticle-containing activated carbon cloth of embodiments may be used in electronic devices and for other uses not associated with chemical agent decontamination.

Although the present invention has been described in considerable detail with reference to certain preferred embodiments thereof, other versions are possible. Therefore the spirit and scope of the appended claims should not be limited to the description and the preferred versions contained within this specification.

1. A composition comprising activated carbon cloth having metal oxide nanoparticles immobilized on a surface of the activated carbon cloth.

2-8. (canceled)

9. The composition of claim 1, wherein the metal oxide nanoparticles comprise about 0.5% to about 10% of the total surface area of the activated carbon cloth.

10. The composition of claim 1, wherein the metal oxide nanoparticles make up about 1% to 50% of the total weight of the composition.

11. The composition of claim 1, wherein the nanoparticles have a BET surface area of about 100 m²/g to about 2000 m²/g.

12. The composition of claim 1, wherein the metal oxide nanoparticles have substantially no agglomeration.

13. The composition of claim 1, wherein the metal oxide nanoparticles comprise at least one metal selected from the group consisting of manganese (Mn), cerium (Ce), vanadium (V), chromium (Cr), iron (Fe), copper (Cu), tin (Sn), molybdenum (Mo), tungsten (W), and combinations thereof.

14. The composition of claim 1, wherein the metal oxide nanoparticles comprise metal oxides selected from the group consisting of MgO, CaO, ZnO, Al₂O₃, TiO₂, V₂O₅, Cr₂O₃, MnO₂, MnO₃, FeO, Fe₂O₃, CoO, NiO, CuO, ZnO, Y₂O₃, ZrO₂, MoO₂, SnO₂, La₂O₃, WO₃, CeOₓ, SiO₂, and combinations thereof.

15. The composition of claim 1, wherein the activated carbon cloth has a surface area of about 100 m²/g to about 2000 m²/g.

16. The composition of claim 1, wherein the activated carbon cloth comprises pores having a mean diameter of 0.3 nm to 3 nm.

17. The composition of claim 1, wherein the activated carbon cloth has an overall porosity of 30% to 50%.

18. A method for making a metal oxide nanoparticle-containing activated carbon cloth comprising:
washing an uncarbonized cloth in a solution containing a Lewis acid containing beryllium (Be), magnesium (Mg), calcium (Ca), strontium (Sr), barium (Ba), radium (Ra), aluminum (Al), scandium (Sc), titanium (Ti), vanadium (V), chromium (Cr), manganese (Mn), iron (Fe), cobalt (Co), nickel (Ni), copper (Cu), zinc (Zn), yttrium (Y), zirconium (Zr), molybdenum (Mo), ruthenium (Ru), silver (Ag), tin (Sn), lanthanum (La), tungsten (W), platinum (Pt), or cerium (Ce);
carbonizing the uncarbonized cloth to produce a carbonized cloth; and
activating the carbonized cloth.

19. The method of claim 18, further comprising drying the uncarbonized cloth before carbonizing.

20. The method of claim 18, further comprising washing the carbonized cloth before activating.

21. The method of claim 18, wherein the activated carbon cloth has a surface area of about 100 m²/g to about 2000 m²/g.

22. The method of claim 18, wherein the activated carbon cloth comprises pores having a mean diameter of 0.3 nm to 3 nm.

23. The method of claim 18, wherein the activated carbon cloth has an overall porosity of 30% to 50%.

24. The method of claim 1, wherein the metal oxide nanoparticle-containing activated carbon cloth comprises nanoparticles of metal oxides selected from the group consisting of MgO, CaO, ZnO, Al₂O₃, TiO₂, V₂O₅, Cr₂O₃, MnO₂, MnO₃, FeO, Fe₂O₃, CoO, NiO, CuO, ZnO, Y₂O₃, ZrO₂, MoO₂, SnO₂, La₂O₃, WO₃, CeOₓ, SiO₂, and combinations thereof.

25. The method of claim 24, wherein the nanoparticles comprise about 0.5% to about 10% of the total surface area of the activated carbon cloth.

26. The composition of claim 24, wherein the nanoparticles make up about 1% to 50% of the total weight of the composition.

27. The composition of claim 1, wherein the nanoparticles have a BET surface area of about 100 m²/g to about 2000 m²/g.
